(19) United States
(12) Patent Application Publication
(10) Pub. No.: US 2006/0272893 A1
(43) Pub. Date: Dec. 7, 2006

(54) Therapeutic foot/leg/knee elevation

(76) Inventors: Joe Foggio, Cumming, GA (US); Vlad Moise, Marietta, GA (US)

Correspondence Address: SEYFARTH SHAW LLP, 131 S. DEARBORN ST., SUITE2400, CHICAGO, IL, 60603-5803, US

(21) Appl. No.: 11/442,465

(22) Filed: May 26, 2006

Related U.S. Application Data
(60) Provisional application No. 60/684,882, filed on May 26, 2005.

(51) Int. Cl. E06C 1/00

(52) U.S. Cl. 182/69.1

(57) ABSTRACT

An adjustable limb support device comprising a front lift and a rear lift, each disposed substantially beneath a top plate. A drive mechanism adapted to drive the front and rear lifts both concurrently and independently, thereby permitting the elevation of the top plate to be raised or lowered and permitting the top plate to tilt off a horizontal plane.

### RELATED APPLICATION

This application claims the benefit of the filing date of co-pending U.S. provisional patent application No. 60/684,882, filed on May 26, 2005.

### BACKGROUND OF THE INVENTION

The present invention relates generally to adjustable limb support devices, and more particularly to adjustable limb support devices having motorized elevation and tilt capabilities.

It is often desirable to elevate the legs of a patient recovering from injuries or illnesses such as strokes, surgeries, or broken bones. As such, adjustable limb support devices are well known in the art. Embodiments of existing devices are generally cumbersome to use, difficult to adjust and/or require mounting to the bed frame. For example, previous embodiments may require manual operation when height adjustment is needed. In such devices, nurses perform the adjustment because patients are generally unable to adjust the height themselves.

It is also known in the art to combine an adjustable limb support device with an electric motor or the like to permit motorized elevation of the limb support platform. Such devices permit the limb support platform to be raised or lowered but fail to provide motorized tilting of the supporting platform off the horizontal plane.

Furthermore, previous embodiments using traditional telescopic elevation mechanisms do not collapse and/or fold down to a sufficiently compact size when the device is not in use, thereby preventing the adjustable limb support device from being sufficiently portable.

Thus, it is desirable to have an adjustable limb support device capable of motorized elevation and motorized tilt of the limb support platform where the elevation and tilt is controlled by a patient via remote control. It is also desirable to have an adjustable limb support device capable of collapsing to a sufficiently compact size when not being used.

### BRIEF SUMMARY OF THE INVENTION

The present invention is an adjustable limb support device having motorized elevation and tilt capabilities. In an embodiment, the adjustable limb support device includes a base that contains the drive mechanism and a supporting platform with a fabric covered contoured foam top that accommodates the patient's limbs.

In an embodiment, the adjustable limb support device includes a front and rear lifts each being of scissors-like construction. The front and rear lifts are substantially collapsible, thereby maximizing and portability and storablilty.

The telescoping motion may also be achieved by any other known mechanism including but not limited to, lead screws and nuts, rack and pinion, toothed belts, pneumatic or hydraulic actuators.

The design illustrated in the following figures consists of two such scissors lifts that can operate simultaneously or independent, one being disengaged from the main drive by means of a clutch or other similar mechanism. When one lift is disengaged, the other lift can travel up or down causing the supporting platform to be positioned at an angle for the user's comfort.

The lifts and the drive mechanism are enclosed by a telescopic protective cover attached to the base and the supporting platform. This cover can be of a bellows type design or series of sliding plates.

### BRIEF DESCRIPTION OF THE DRAWINGS

For the purpose of facilitating an understanding of the subject matter sought to be protected, there is illustrated in the accompanying drawings embodiments thereof, from an inspection of which, when considered in connection with the following description, the subject matter sought to be protected, its construction and operation, and many of its advantages, should be readily understood and appreciated.

FIG. 1 is a perspective view of the first embodiment of the adjustable limb support device showing the front and rear lifts exposed.

FIG. 2 is a perspective view of the base of the first embodiment of the device showing the drive mechanism details.

FIG. 3 is a perspective view of the underside of the base showing more details of the drive mechanism.

FIG. 4 is a perspective view of the first embodiment of the invention showing the lift mechanism attached to the drive slides.

FIG. 5 is a detail perspective view of the top plate pivot block assembly.

FIG. 6 is a perspective view of the device with the top plate installed on top of the lift.

FIG. 7 is a perspective view of the device showing the underside of the top plate assembly.

FIG. 8 is a perspective view of the device in the lowest position.

FIG. 9 is perspective view of the elevation device in its retracted position with the limb support platform attached to the top plate.

FIG. 10 is a perspective view of the device, with the protective cover on, in the lowest position.

FIG. 11 is a perspective view of the assembled device in the elevated position.

### DETAILED DESCRIPTION

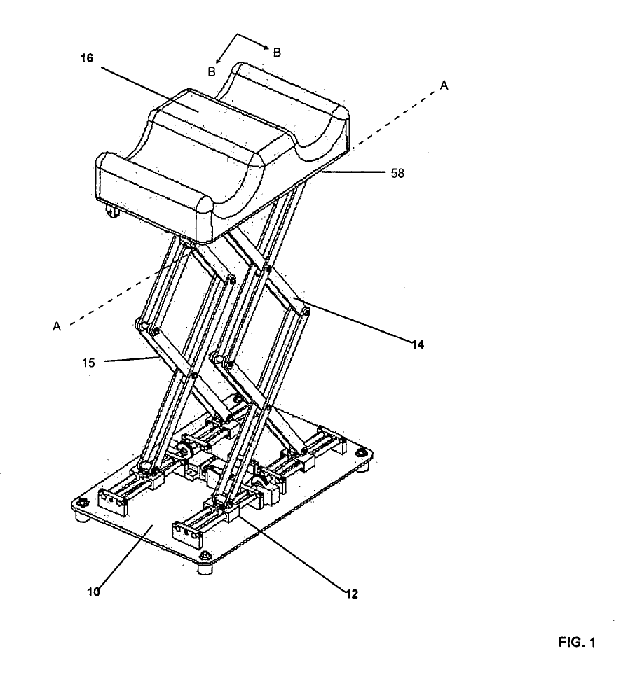

Referring to FIG. 1 an embodiment of the adjustable limb support device of the present application is shown. In an embodiment, the adjustable limb support device includes a drive mechanism 12 mounted to a base 10. The drive mechanism 12 is adapted to drive a front lift 14 and a rear lift 15, whereby the front and rear lifts 14, 15 may be driven concurrently or independently. As such, the front and rear lifts 14, 15 are adapted to raise and lower a top plate 58 and limb support platform 16. The front and rear lifts 14, 15 can also be driven independently such that the top plate 58 is permitted to rotate about a pivot axis A-A, thereby causing the top plate 58 and limb support platform 16 to be tilted off a horizontal plane B-B.

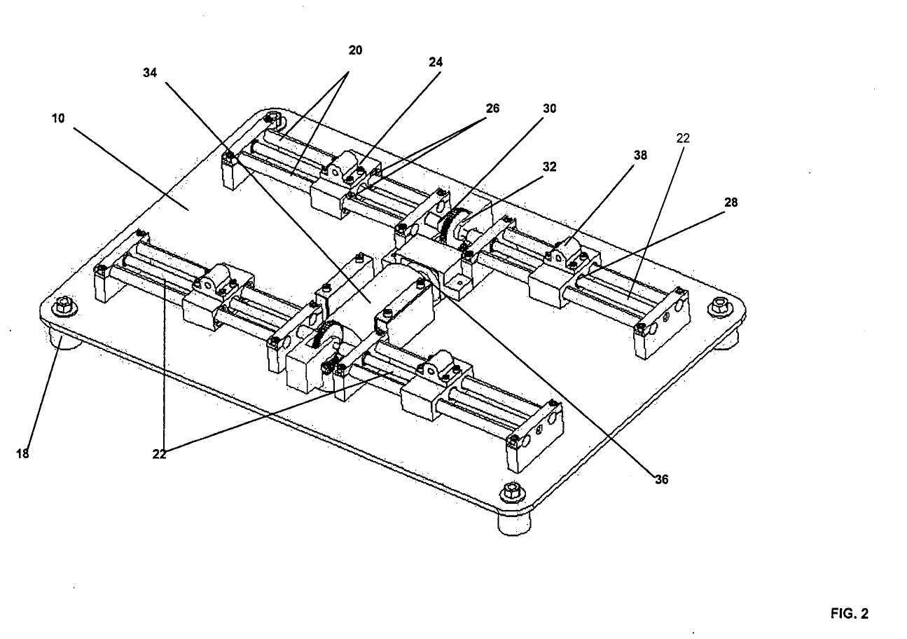

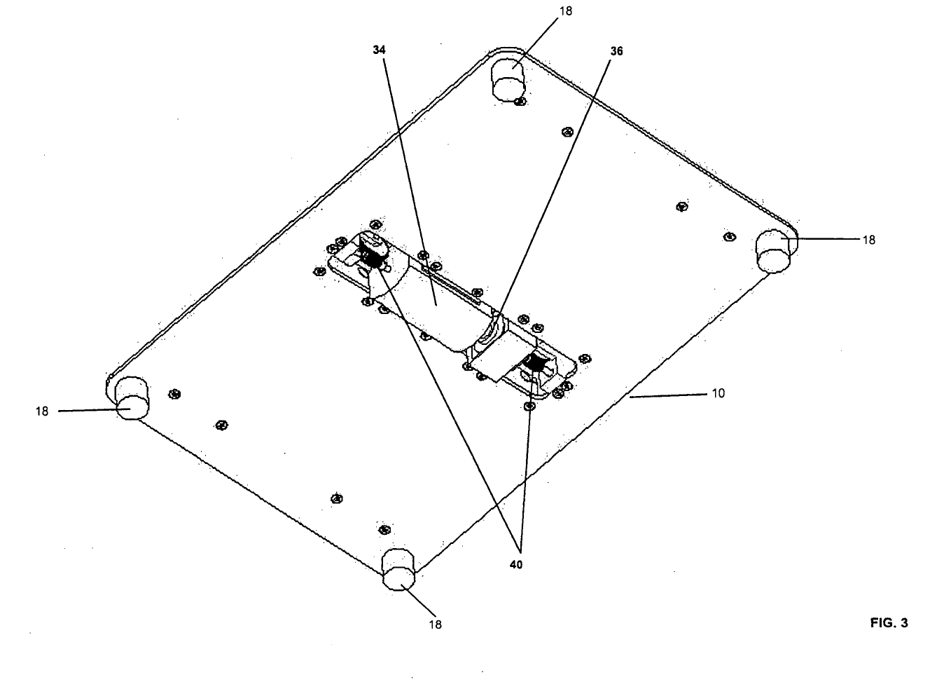

Referring also to FIG. 2. The base 10 may include elastomer feet 18 to increase its stability when placed on a floor or on a bed. The drive mechanism 12 includes of linear bearing shafts 20, left hand and right hand lead screws 22 and linear slides 24. Linear bearings 26 and left hand and right hand lead screw nuts 28 are mounted to the slides 24. Also scissors lift mounting brackets 38 are attached or part of the linear slides 24. Using couplings 30, the worm gears 32 engage the four sides of the drive mechanism 12. Worms 40, shown in FIG. 3 drive the worm gears 32. The linear slides activate the front and rear lifts 14, 15. The front and rear lifts 14, 15 may be driven concurrently, whereby the top plate 58 remains at a horizontal plane. The drive mechanism 12 may also drive the front and rear lifts 14, 15 independently.

FIG. 3 also shows that one worm 40 is attached to one end of a reversible motor 34 shaft. The other end of the drive shaft drives a clutch 36 and the second worm 40. While an embodiment of the drive mechanism 12 having one reversible motor 40 is being disclosed in detail herein, drive mechanisms having multiple motors are also possible.

When the clutch 36 is engaged, the front and rear lifts 14, 15 are driven concurrently, thereby permitting the limb support platform 16 to be raised or lowered depending on whether the drive motor 34 rotation clockwise or counter clockwise. If the clutch 36 is disengaged, the motor 34, by means of the worm 40 attached to its drive shaft and through the worm gear 32, drives only the rear lift 15 causing the limb support platform 16 to pivot about the pivot axis A-A. Tilting of the limb support platform 16 can be effectuated by disengaging the clutch 36.

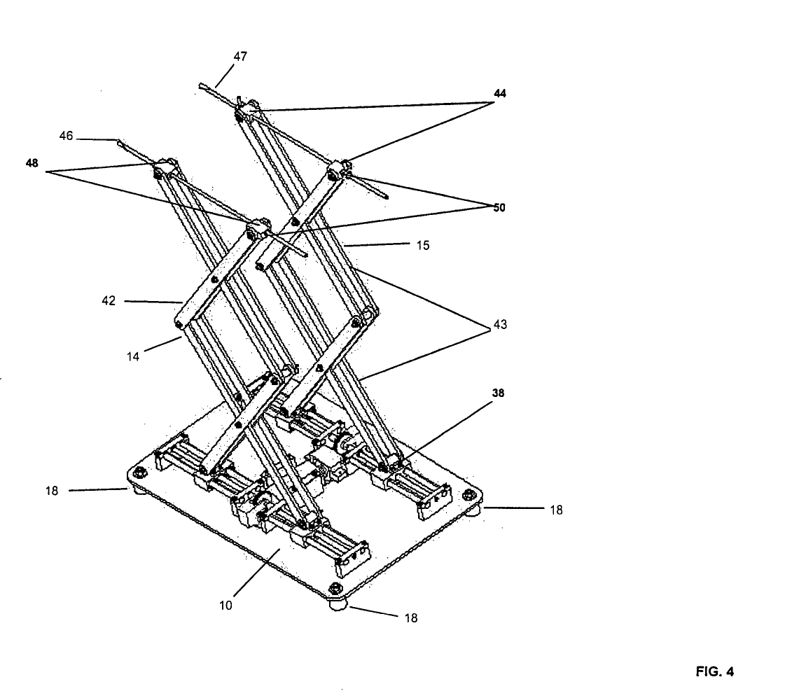

Referring also go FIG. 4, the front and rear lifts 14, 15 are of scissors-like construction. As such, the front and rear lifts 14, 15 comprise pairs of front and rear articulated lift bars 42, 43 that form the two independent sides. The lower end of the articulated lift bars 42, 43 are attached to the mounting brackets 38. Two pivot blocks 44 are disposed at the top of the rear lift 15 between the lift bars 42. Two platform blocks 48 are disposed at the top of the front scissors mechanism 14 between the lift bars 42, 43. A rear linear rod 47 aligns the pivot blocks 44 and a front linear rod 46 aligns the platform blocks 48. The pivot blocks 44 and platform blocks 48 contain linear bearings 50 providing smooth lateral motion as the front and rear lifts 14, 15 are driven to various elevations.

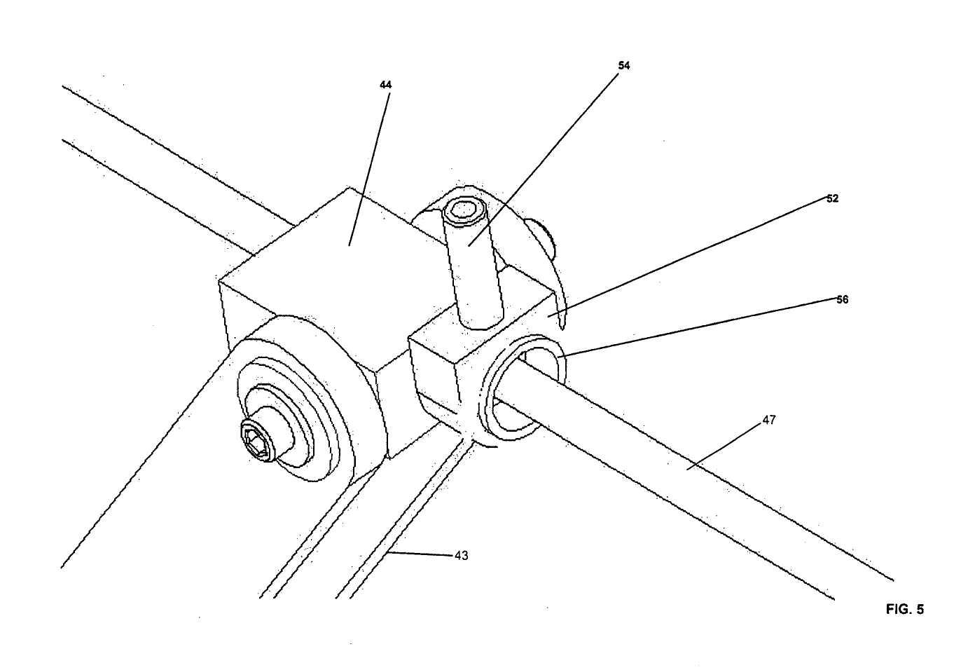

Referring to FIG. 5, rotation is also permitted at the rear linear rod 47 because of the top plate pivot 52. The top plate pivot 52 includes a top plate pivot pin 54 and can freely rotate around the pivot block shoulder 56 that is part of the pivot block 44.

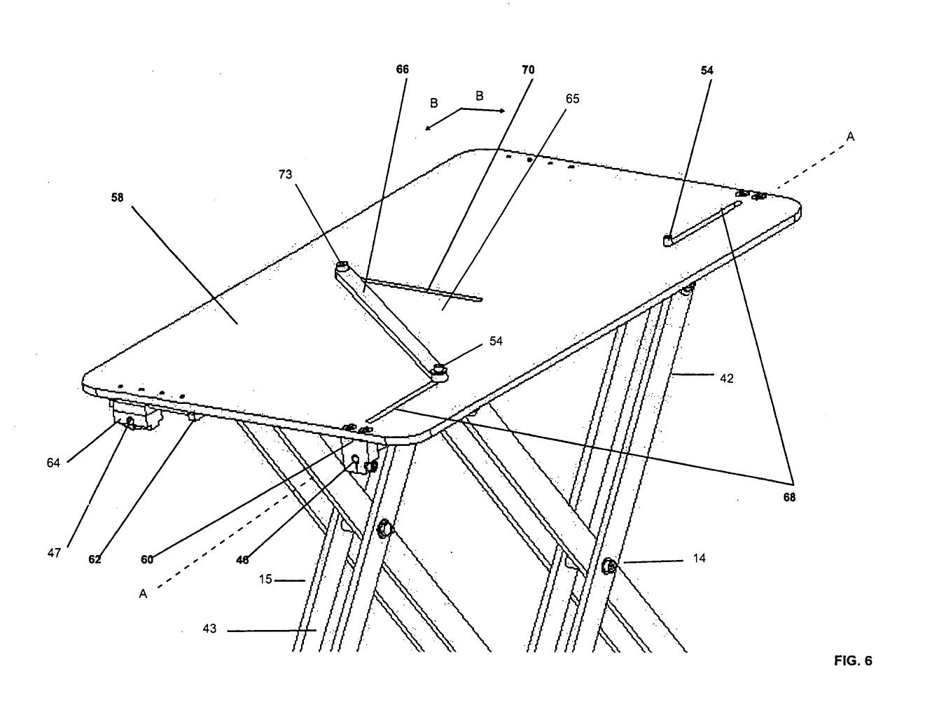

Referring also to FIG. 6, the top plate 58 is supported by the front and rear lifts 14, 15. Pivot shaft supports 60 are attached to the top plate 58, one on each side, connecting the front linear rod 46 to the top plate 58. The top plate pivot pins 54 of the top plate pivots 52 slide into the slots 68 provided in the top plate 58 as the front and rear lifts 14, 15 move up or down. When the tilting action is engaged, the top plate 58 rotates about the pivot axis A-A at the front linear rod 46 secured by the pivot shaft supports 60. At the top of the front lift 14, the horizontal slots 68 in the top plate 58 allow smooth motion of the pivot blocks 44 and prevent any front to back motion of the top plate 58.

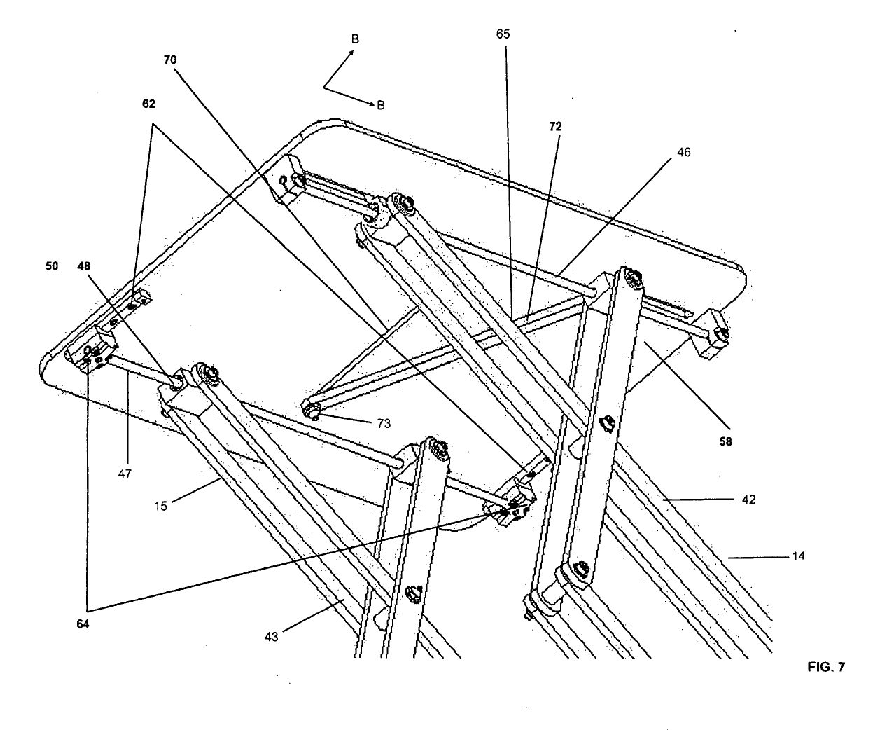

Referring also to FIG. 7 a triangular articulated centering mechanism 65 is displayed in more detail. The triangular articulated centering mechanism 65 includes an upper centering arm 66 and lower centering arm 72 that substantially prevent lateral motion thereby substantially ensuring the top plate 58 remains centered relative to the front and rear lifts 15, 16. The upper centering arm 66 is connected to the lower centering arm 72 through a link 73, where the link 73 is permitted to slideably engage a vertical slot 70. The other end of the upper centering arm 66 is attached to one of the top plate pivot pin 54 and can rotate about the tip plate pivot pin 54 as the platform moves up and down. The top plate 58 must not only rotate about the pivot axis A-A at the front linear rod 46 but it must also slide back and forth as it raises or lowers allowing the front linear rod 46 to remain in a fixed vertical plane since it is attached to the front lift 14. For this purpose, linear slide rails 62 are disposed at the top of the rear lift 15. The linear slide rails 62 are attached on each side of the top plate 58 supporting the slide blocks 64, which secure the rear linear rod 47.

FIG. 7 shows the underside of the top plate 58 mechanism. The lower centering arm 72 is also attached to the upper centering arm 66 at one end and to the other top plate pivot pin 54. This arrangement displayed in FIG. 7 is a creates a triangular articulated centering mechanism 65 where the lower and upper centering arms 72, 66 keep the top plate 58 centered. The FIG. 7 also shows the slide rails 62 and the slide blocks 64 in the forward position, the top plate is disposed substantially along the horizontal plane B-B. The platform blocks 48, attached to the top of the front lift 14, are of the same design as the pivot blocks 44 described in FIGS. 4-5 using the same linear bearings 50.

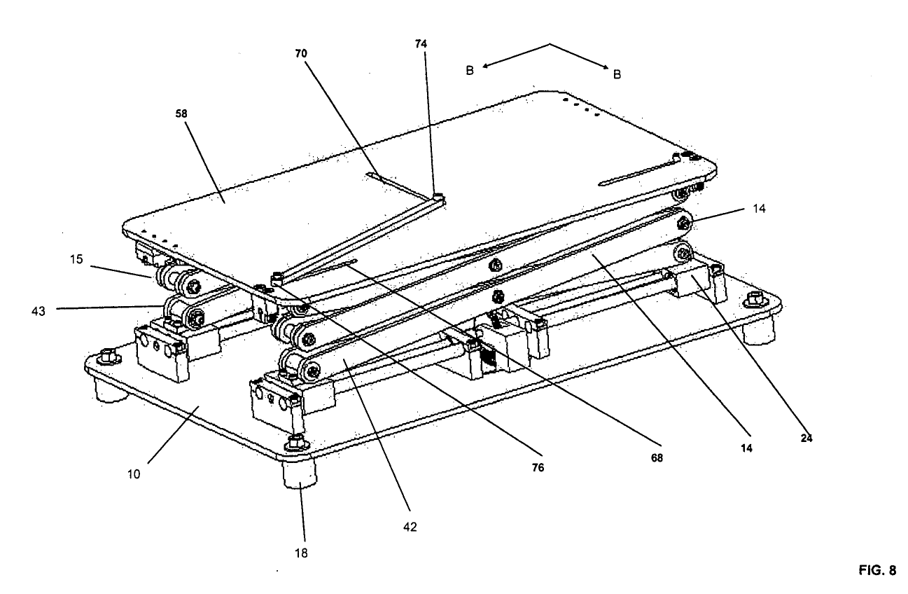

Referring also to FIG. 8, the adjustable limb support device is shown in a retracted position. In a retracted position, the front and rear lifts 14, 15 substantially collapse into themselves as the elevation of the top plate 58 approaches the elevation of the base 10. The centering arms connection point 74 is at its reverse position, at the rear end of the vertical slot 70. The centering arm to top plate pivot pin connection 76 is at its outermost position in the horizontal slot 68.

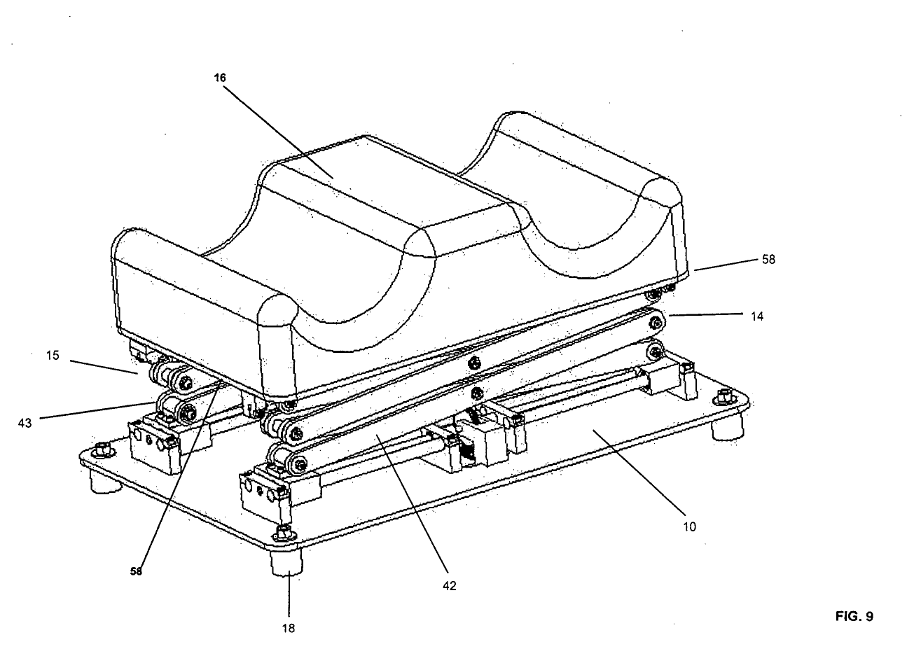

Referring also to FIG. 9, showing the adjustable limb support device in the retracted position, the limb support platform 16 is attached to the top plate 58. In this configuration the device can be used on a bed. The patient lying down can rest his or her feet/legs/knees on the limb support platform 16. The limb support platform 16 can be slightly raised and tilted to provide maximum comfort.

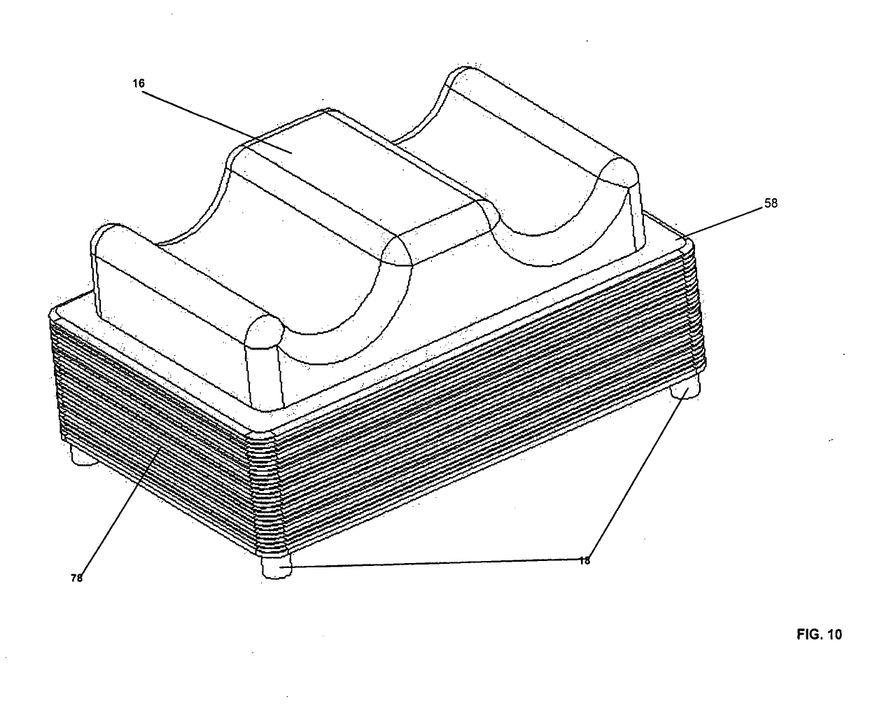

Referring also to FIG. 10, the adjustable limb support device is shown fully assembled and in the retracted position. The rubber feet 18 are exposed in order to provide stability when the elevation device is placed on a bed or on the floor. The limb support platform 16 is attached to the front and rear lifts 14, 15 and a protective cover 78 surrounds the unit to prevent access to the internal mechanism and electrical connections.

The protective cover 78 may resemble an accordion or bellows. The protective cover 78 can also be designed and manufactured as a series of telescopic plates that restrict the access to the internal components.

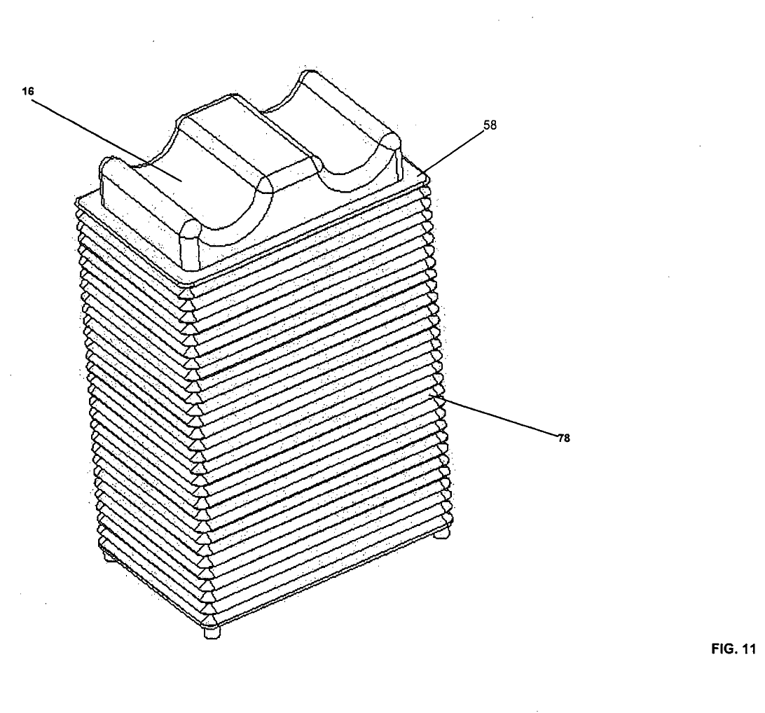

Referring also to FIG. 11, the adjustable limb support device is shown in an elevated position. The protective cover 78, attached to the base and the top plate, expands to accommodate the change in height.

An alternative embodiment of the adjustable limb support device may comprise round, square or rectangular telescopic column placed in the center of the base. The first section is fixed, attached to the base while the additional sections nest inside each other in the collapsed position. When extended, the tubular sections slide past each other and remain engaged enough to provide a solid support under load. Such a mechanism could be driven by lead screws and nuts, rack and pinion mechanisms, toothed belts, pneumatic or hydraulic systems. A separate drive mounted under the top plate could provide the tilting motion. The top plate would be attached to the last telescopic section.

Another alternative embodiment the adjustable limb support device may be designed to provide four telescopic columns connecting the four corners of the base to the four corners of the top plate. All four columns could be driven simultaneously to create the up and down motion or one pair of columns could be disconnected from the driving mechanism, by means of a clutch, to create the tilting motion.

A further alternative embodiment, includes separate drive motors for each, scissor lift. Each motor can be activated simultaneously for up and down motion or independently for bi-directional tilt.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. An adjustable limb support device comprising:
a front lift and a rear lift, each disposed substantially beneath a top plate; and
a drive mechanism adapted to drive the front and rear lifts both concurrently and independently, thereby permitting the elevation of the top plate to be raised or lowered and permitting the top plate to tilt off a horizontal plane.

2. The device of claim 1 whereby the elevation and tilting of the top plate may be operated by a hand-held remote control.

3. The device of claim 1 wherein the drive mechanism is further defined as comprising a double shaft reversible electric motor.

4. The device of claim 3 further comprising a triangular articulated centering mechanism that is engaged by one of the front or rear lifts and disposed substantially adjacent to the top plate, whereby the top plate is permitted remain substantially laterally centered relative to the front and rear lifts when elevation or tilting occurs.

5. The device of claim 4 wherein the front and rear lifts are of scissors-like construction.

6. An adjustable limb support device comprising:
a front lift and a rear lift, each disposed substantially beneath a top plate and each being of scissors-like construction;
a drive mechanism adapted to drive the front and rear lifts both concurrently and independently, thereby permitting the elevation of the top plate to be raised or lowered and permitting the top plate to tilt off a horizontal plane.

7. The device of claim 6 wherein the drive mechanism is further defined as being a double shaft reversible electric motor.

8. The device of claim 7 further comprising a triangular articulated centering mechanism that is engaged by one of the front or rear lifts and disposed substantially adjacent to the top plate, whereby the top plate is permitted remain substantially laterally centered relative to the front and rear lifts when elevation or tilting occurs.

9. The device of claim 7 whereby the elevation and tilting of the top plate may be operated by a hand-held remote control.

10. The device of claim 6 wherein the drive mechanism is further defined as comprising an air compressor and controlled by a valve system.

11. The device of claim 6 wherein the drive mechanism is further defined as using hydraulic components driven by a hydraulic system and controlled by a valve system.

12. The device of claim 6 further comprising a base disposed beneath the front and rear lifts wherein the base is supported by elastomer feet.
